(19) United States
(12) Patent Application Publication
(10) Pub. No.: US 2024/0349172 A1
(43) Pub. Date: Oct. 17, 2024

(54) APPARATUS COMPRISING AT LEAST ONE PROCESSOR

(71) Applicant: Nokia Technologies Oy, Espoo (FI)

(72) Inventors: Mads LAURIDSEN, Aalborg (DK); Jeroen WIGARD, Aalborg (DK); Rafhael MEDEIROS DE AMORIM, Aalborg (DK); Srinivasan SELVAGANAPATHY, Bangalore (IN)

(21) Appl. No.: 18/294,404

(22) PCT Filed: Aug. 1, 2022
(86) PCT No.: PCT/EP2022/071557

§ 371 Date: Feb. 1, 2024

(30) Foreign Application Priority Data
Aug. 5, 2021 (IN) 202141035325

(51) Int. Cl. H04W 48/04; H04W 48/12

(52) U.S. Cl. CPC H04W 48/04; H04W 48/12

(57) ABSTRACT

An apparatus, comprising at least one processor, and at least one memory storing instructions, the at least one memory and the instructions configured to, with the at least one processor, cause a network device, which provides a first radio cell, to transmit a first information characterizing a radio coverage of at least one further radio cell of at least one further network device, which at least temporarily and at least partially covers a neighbor area of the first radio cell.

### FIELD OF THE DISCLOSURE

Various example embodiments relate to an apparatus comprising at least one processor.

Further embodiments relate to a method of operating related to such apparatus.

### BACKGROUND

Wireless communications systems may e.g. be used for wireless exchange of information between two or more entities, e.g. comprising one or more terminal devices, e.g. user equipment, and one or more network devices such as e.g. base stations.

### SUMMARY

Various embodiments of the disclosure are set out by the independent claims. The exemplary embodiments and features, if any, described in this specification, that do not fall under the scope of the independent claims, are to be interpreted as examples useful for understanding various exemplary embodiments of the disclosure.

Some exemplary embodiments relate to an apparatus, comprising at least one processor, and at least one memory storing instructions, the at least one memory and the instructions configured to, with the at least one processor, cause a network device, which provides a first radio cell, to transmit a first information characterizing a radio coverage of at least one further radio cell of at least one further network device, which at least temporarily and at least partially covers a neighbor area of the first radio cell.

In some embodiments, the apparatus may be an apparatus for a wireless communications system.

In some embodiments, the apparatus or its functionality, respectively, may be provided in a network device, for example network node, of the communications system, for example in a base station, e.g. gNodeB (gNB).

In some embodiments, the apparatus according to the embodiments or its functionality, respectively, may be used for or within wireless communications systems, e.g. networks, based on or at least partially adhering to third generation partnership project, 3GPP, radio standards such as 5G (fifth generation) or other radio access technology.

Some embodiments enable to provide information related to radio coverage, for example discontinuous coverage, to one or more terminal devices, for example user equipment (UE), for example in an efficient way.

In some embodiments, transmitting the first information may for example be performed via broadcasting. In some embodiments, this enables to reduce or minimize a signaling overhead and UE power consumption. In some embodiments, via broadcasting, the first information can efficiently be made available to UE which are in an idle state, such as a Radio Resource Control, RRC, Idle state according to some accepted standards, as well as to connected UE, which may e.g. be in an RRC Connected state.

In some embodiments, the first information may enable UEs to choose among multiple coverage times, such that they may adapt their sleep e.g. to their traffic profile. For example, in some embodiments, some UEs may transfer data every 15 minutes, while others do so once per day.

In some embodiments, at least one of the network device and the at least one further network device is a mobile network device, for example a non-terrestrial network device, e.g. provided in or through a satellite, e.g. in case of a transparent architecture. In some embodiments, the network device and/or the at least one further network device may also be provided on a vehicle, for example land craft and/or water craft and/or aircraft and/or spacecraft. Using the principle according to the embodiments, information related to discontinuous coverage, which may arise from an operation of the mobile network device(s), can efficiently be provided.

In some embodiments, the first information comprises at least one of: a) first position information characterizing at least one position, for example orbital position (e.g., in case of a satellite-bound network device or spacecraft), of the at least one further network device, b) a timestamp characterizing a time and/or date on which the at least one further network device is at the at least one position, c) second position information characterizing at least one center position of the at least one further radio cell, d) a time difference between two points in time, wherein each of the two points in time is associated with a respective position of the at least one further network device or a respective center position of the at least one further radio cell, e) an estimated coverage radius (and/or other parameter characterizing a coverage area) of the at least one further radio cell, f) a first indicator indicating that an estimated coverage radius of the at least one further radio cell is at least similar to a coverage radius of the first radio cell, g) first angle-based position information characterizing at least one angle at which a trajectory of the at least one further network device passes a circle centered at at least one of a center of the first radio cell or a current position of the network device, h) second angle-based position information characterizing at least one angle at which a trajectory of the at least one further network device leaves a circle centered at at least one of a center of the first radio cell or a current position of the network device.

In some embodiments, “center position of the at least one further radio cell” or “center position of a radio cell” in general denotes a cell coverage center location on Earth.

In some embodiments, the second position information may characterize a radio coverage of e.g. an entire satellite (or its associated network device, respectively), i.e. at least one radio cell.

In some embodiments, the first cell and the at least one further cell may at least partially temporarily overlap. In some other embodiments, the first cell and the at least one further cell may not overlap.

In some embodiments, the first information may characterize coverage information, for example per future cell (e.g., per cell which may in future at least temporarily provide radio coverage in the neighbor area of the first cell), which may include:
a) (at least) two orbital positions of a satellite carrying the at least one further network device (which may provide a “future cell”). In some embodiments, one of the at least two positions may be linked to a coverage of the current, i.e. first, cell, i.e. characterizing when the future cell is within a certain range of the current cell. In some embodiments, the first orbital position may be complemented with a time stamp of when the satellite is in the specific position.
b) In some embodiments, e.g. alternatively, the two positions can point to the cell center of a target cell at two different points in time. In some embodiments, this may also enable the UE to estimate a cell movement over time.
c) In some embodiments, a delta time (Δt) between a first and the second position may be standardized and/or broadcasted, such that the UE can interpret the meaning of the two positions and e.g. determine satellite movement speed and the approximate orbit of the satellite.
d) In some embodiments, an estimated coverage radius of the future cell (e.g., the radio cell as may be provided by the at least one further network device) may be included in the first information and/or may be indicated to be the same as the current cell, e.g. by the first indicator mentioned above. In some embodiments, e.g., alternatively, the entire constellation of further network devices can have a same coverage radius per cell, which, in some embodiments, may e.g. be preconfigured in the UE.

While various exemplary embodiments are described in the context of cell coverage, it is noted that the principle according to the embodiments may also be expanded to be satellite coverage, i.e. the coverage of more than one cell. In some embodiments, this may make a link between coverage on earth and satellite position simpler.

In some embodiments, the first information characterizes at least one of: a) a radio coverage of a predetermined first number of further radio cells of the at least one further network device, which will at least temporarily cover the neighbor area of the first radio cell within a predetermined first time interval, b) a radio coverage of a predetermined second number of further radio cells of the at least one further network device, which will at least temporarily cover the neighbor area of the first radio cell within a predetermined second time interval following the first time interval. In some embodiments, the first time interval may comprise several minutes or hours. In some embodiments, the second time interval may comprise several hours or days. In some embodiments, this enables UE to flexibly schedule sleep and/or wakeup periods, for example taking into account operational requirements of the UE. As an example, this may enable UEs with infrequent traffic to sleep for extended periods of time (e.g. 24 hours or more), while also avoiding them becoming “blind” in terms of future coverage.

In some embodiments, the instructions, when executed by the at least one processor, further cause the network device to indicate a change of the first information. This way, UE may be notified of updates regarding the first information.

In some embodiments, changes or updates of the first information may also be excluded from a change indication, for example a system information change indication according to some accepted standards (i.e. no triggering of UE via paging message, for example), for example because once the UE has read the coverage information from the current cell it does not necessarily need to reread until some future cell provides coverage.

In some embodiments, for example in the instance where a UE calculates that all (future) cells listed in the current coverage information as e.g. characterized or represented by the first information, will not provide coverage to the location of the UE, the UE may seek to get new information, e.g. by requesting transmission of the first information.

In some embodiments, a UE may decide to re-read the coverage information as e.g. characterized or represented by the first information, e.g. when the satellite is closer to the location of the UE, since it may essentially mean the coverage information may contain more relevant cells for that UE.

In some embodiments, the instructions, when executed by the at least one processor, further cause the network device to: receive a request for transmission of the first information, and, optionally, to transmit the first information upon the request.

In some embodiments, the request may comprise an indication from a terminal device about a certain time window, for example where the terminal device would like to know about the coverage. As an example, with the indication, the terminal device may ask or instruct the network device to e.g. inform the terminal device about a coverage in a time window of 4-8 hours from now.

In some embodiments, the request may also comprise an indication from a terminal device about the location of the terminal device in the certain time window. In some embodiments, this enables the terminal device to request information about coverage at another location, for example a location it expects to move there for the certain time window.

Some exemplary embodiments relate to a method comprising: transmitting, by a network device, which provides a first radio cell, a first information characterizing a radio coverage of at least one further radio cell of at least one further network device, which at least temporarily and at least partially covers a neighbor area of the first radio cell.

Some exemplary embodiments relate to an apparatus comprising means for causing a network device, which provides a first radio cell, to transmit, a first information characterizing a radio coverage of at least one further radio cell of at least one further network device, which at least temporarily and at least partially covers a neighbor area of the first radio cell.

Some exemplary embodiments relate to an apparatus, comprising at least one processor, and at least one memory storing instructions, the at least one memory and the instructions configured to, with the at least one processor, cause a terminal device served by a first network device in a first radio cell to receive a first information characterizing a radio coverage of at least one further radio cell of at least one further network device, which at least temporarily and at least partially covers a neighbor area of the first radio cell.

In some embodiments, the first information comprises at least one of: a) first position information characterizing at least one position, for example orbital position, of the at least one further network device, b) a timestamp characterizing a time and/or date on which the at least one further network device is at the at least one position, c) second position information characterizing at least one center position of the at least one further radio cell, d) a time difference between two points in time, wherein each of the two points in time is associated with a respective position of the at least one further network device or a respective center position of the at least one further radio cell, e) an estimated coverage radius of the at least one further radio cell, f) a first indicator indicating that an estimated coverage radius of the at least one further radio cell is at least similar to a coverage radius of the first radio cell, g) first angle-based position information characterizing at least one angle at which a trajectory of the at least one further network device passes a circle centered at at least one of a center of the first radio cell or a current position of the network device, h) second angle-based position information characterizing at least one angle at which a trajectory of the at least one further network device leaves a circle centered at at least one of a center of the first radio cell or a current position of the network device.

In some embodiments, the instructions, when executed by the at least one processor, further cause the terminal device to request a transmission of the first information.

In some embodiments, the request for the transmission may comprise an indication from a terminal device about a certain time window, for example where the terminal device would like to know about the coverage. As an example, with the indication, the terminal device may ask or instruct the network device to e.g. inform the terminal device about a coverage in a time window of 4-8 hours from now.

In some embodiments, the request for the transmission may also comprise an indication from a terminal device about the location of the terminal device in the certain time window. In some embodiments, this enables the terminal device to request information about coverage at another location, for example a location it expects to move there for the certain time window.

In some embodiments, the instructions, when executed by the at least one processor, further cause the terminal device to perform, based at least partially on the first information, at least one of: a) controlling an operation of the terminal device, b) entering a sleep state, c) waking up from a sleep state.

In some embodiments, the instructions, when executed by the at least one processor, further cause the terminal device to: determine one or more time windows with radio coverage provided by at least one of a) the network device and/or b) the at least one further network device, and, optionally, to monitor for paging within at least one of the one or more time windows.

Some exemplary embodiments relate to a method comprising: receiving, by a terminal device served by a first network device in a first radio cell, a first information characterizing a radio coverage of at least one further radio cell of at least one further network device, which at least temporarily and at least partially covers a neighbor area of the first radio cell.

Some exemplary embodiments relate to an apparatus comprising means for causing a terminal device served by a first network device in a first radio cell to receive a first information characterizing a radio coverage of at least one further radio cell of at least one further network device, which at least temporarily and at least partially covers a neighbor area of the first radio cell.

Some exemplary embodiments relate to a wireless communications system comprising at least one apparatus according the embodiments.

### BRIEF DESCRIPTION OF THE FIGURES

FIG. 1 schematically depicts a simplified block diagram of an apparatus according to some embodiments,

FIG. 2 schematically depicts a simplified block diagram of an apparatus according to some embodiments,

FIG. 3 schematically depicts a simplified block diagram according to some embodiments,

FIG. 4 schematically depicts a simplified flow chart according to some embodiments,

FIG. 5 schematically depicts a simplified block diagram according to some embodiments,

FIG. 6 schematically depicts a simplified flow chart according to some embodiments,

FIG. 7 schematically depicts a simplified flow chart according to some embodiments,

FIG. 8 schematically depicts a simplified flow chart according to some embodiments,

FIG. 9 schematically depicts a simplified flow chart according to some embodiments,

FIG. 10 schematically depicts a simplified flow chart according to some embodiments,

FIG. 11 schematically depicts an exemplary scenario according to some embodiments,

FIG. 12 schematically depicts an exemplary scenario according to some embodiments,

FIG. 13 schematically depicts a signaling diagram according to some embodiments,

FIG. 14 schematically depicts an exemplary scenario according to some embodiments,

FIG. 15 schematically depicts a simplified block diagram according to some embodiments,

FIG. 16 schematically depicts a simplified block diagram according to some embodiments.

### DESCRIPTION OF SOME EXEMPLARY EMBODIMENTS

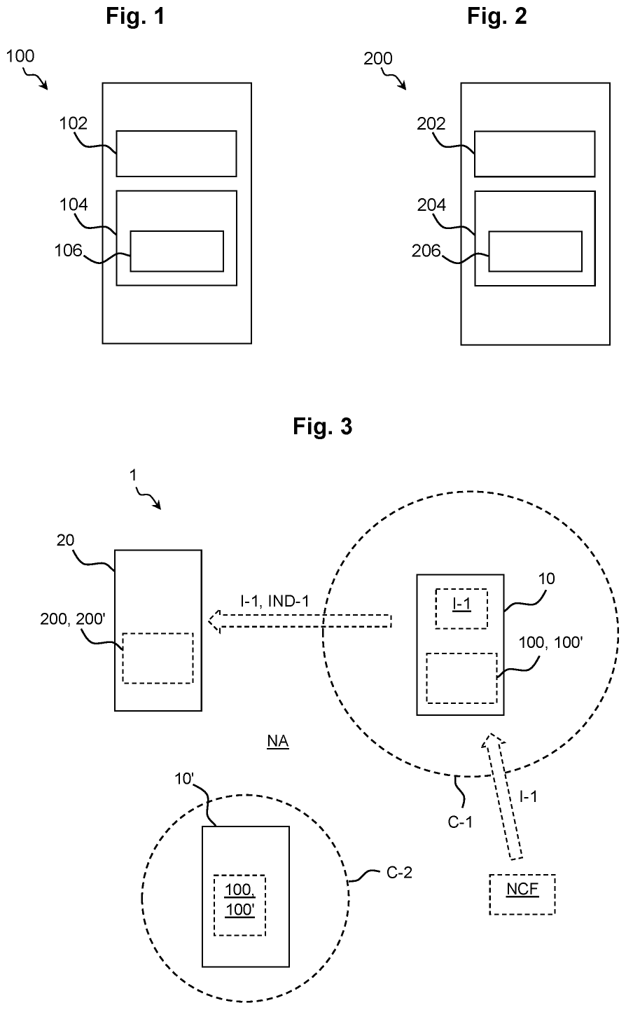

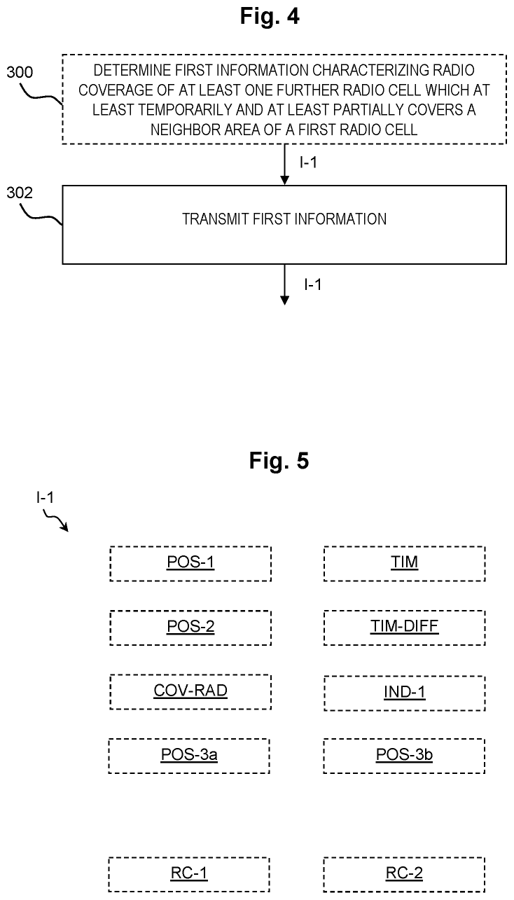

Some exemplary embodiments, see for example FIG. 1, 3, 4, relate to an apparatus 100, comprising at least one processor 102, and at least one memory 104 storing instructions 106, the at least one memory 104 and the instructions 106 configured to, with the at least one processor 102, cause a network device 10 (FIG. 3), which provides a first radio cell C-1, to transmit 302 (FIG. 4) a first information I-1 characterizing a radio coverage of at least one further radio cell C-2 (FIG. 3) of at least one further network device 10′, which at least temporarily and at least partially covers a neighbor area NA of the first radio cell C-1.

In some embodiments, the apparatus 100 may be an apparatus for a wireless communications system 1.

In some embodiments, the apparatus 100 or its functionality, respectively, may be provided in a network device 10, for example network node, of the communications system, for example in a base station, e.g. gNodeB (gNB) 10.

In some embodiments, the apparatus 100 according to the embodiments or its functionality, respectively, may be used for or within wireless communications systems 1, e.g. networks, based on or at least partially adhering to third generation partnership project, 3GPP, radio standards such as 5G (fifth generation) or other radio access technology.

Some embodiments enable to provide information related to radio coverage, for example discontinuous coverage, to one or more terminal devices 20, for example user equipment (UE), for example in an efficient way.

In some embodiments, transmitting 302 the first information I-1 may for example be performed via broadcasting. In some embodiments, this enables to reduce or minimize a signaling overhead and UE power consumption. In some embodiments, via broadcasting, the first information I-1 can efficiently be made available to UE 20 which are in an idle state, such as a Radio Resource Control, RRC, Idle state according to some accepted standards, as well as to connected UE, which may e.g. be in an RRC Connected state.

In some embodiments, transmitting 302 the first information I-1 may be performed repeatedly, for example periodically.

In some embodiments, transmitting 302 the first information I-1 may be performed in a time-multiplexed manner, e.g. time-multiplexed with other information to be transmitted, for example broadcasted, by the network device 10.

In some embodiments, the first information I-1 may enable UEs 20 to choose among multiple coverage times, such that they may adapt their sleep e.g. to their traffic profile. For example, in some embodiments, some UEs may transfer data every 15 minutes, while others do so once per day, and in some embodiments, some or all of such UEs may benefit from the first information I-1.

In some embodiments, at least one of the network device 10 and the at least one further network device 10′ is a mobile network device, for example a non-terrestrial network device, e.g. provided in or through a satellite. In some embodiments, the network device 10 and/or the at least one further network device 10′ may also be provided on a vehicle, for example land craft and/or water craft and/or aircraft and/or spacecraft. Using the principle according to the embodiments, information related to discontinuous coverage, which may arise from an operation of the mobile network device(s), can efficiently be provided.

In some embodiments, FIG. 4, prior to transmitting 302, the network device 10 may determine the first information I-1.

In some embodiments, a network control function NCF (FIG. 3) may determine the first information I-1, and may provide it e.g. to the network device 10. I.e., in some embodiments, determining 300 the first information I-1 by the network device 10 may comprise receiving (at least parts of) the first information I-1 from another entity, e.g. the network control function NCF.

In some embodiments, FIG. 5, the first information I-1 comprises at least one of: a) first position information POS-1 characterizing at least one position, for example orbital position (e.g., in case of a satellite-bound network device 10′ or spacecraft), of the at least one further network device 10′, b) a timestamp TIM characterizing a time and/or date on which the at least one further network device 10′ is at the at least one position, c) second position information POS-2 characterizing at least one center position of the at least one further radio cell C-2, d) a time difference TIM-DIFF between two points in time, wherein each of the two points in time is associated with a respective position of the at least one further network device 10′ or a respective center position of the at least one further radio cell C-2, e) an estimated coverage radius (and/or other parameter characterizing a coverage area) COV-RAD of the at least one further radio cell C-2, f) a first indicator IND-1 indicating that an estimated coverage radius of the at least one further radio cell C-2 is at least similar to a coverage radius of the first radio cell C-1, g) first angle-based position information POS-3a characterizing at least one angle at which a trajectory of the at least one further network device 10′ passes a circle centered at at least one of a center of the first radio cell C-1 or a current position of the network device 10, h) second angle-based position information PSO-3b characterizing at least one angle at which a trajectory of the at least one further network device 10′ leaves a circle centered at at least one of a center of the first radio cell C-1 or a current position of the network device 10.

In some embodiments, the first cell C-1 and the at least one further cell C-2 (FIG. 3) may at least partially temporarily overlap. In some other embodiments, the first cell C-1 and the at least one further cell C-2 may not overlap, as exemplarily depicted by FIG. 3.

In some embodiments, the first information I-1 may characterize coverage information, for example per future cell (e.g., per cell which may in future at least temporarily provide radio coverage in the neighbor area of the first cell), which may include:
a) (at least) two orbital positions of a satellite carrying the at least one further network device 10′ (which may provide a “future cell”). In some embodiments, one of the at least two positions may be linked to a coverage of the current, i.e. first, cell, i.e. characterizing when the future cell is within a certain range of the current cell C-1. In some embodiments, the first orbital position may be complemented with a time stamp of when the satellite is in the specific position.
b) In some embodiments, e.g. alternatively, the two positions can point to the cell center of a target cell C-2 at two different points in time. In some embodiments, this may also enable the UE 20 to estimate a cell movement over time.
c) In some embodiments, a delta time (Δt) between a first and the second position may be standardized and/or broadcasted, such that the UE 20 can interpret the meaning of the two positions and e.g. determine satellite movement speed and the approximate orbit of the satellite.
d) In some embodiments, an estimated coverage radius of the future cell (e.g., the radio cell as may be provided by the at least one further network device) C-2 may be included in the first information I-1 and/or may be indicated to be the same as the current cell, e.g. by the first indicator IND-1 mentioned above. In some embodiments, e.g., alternatively, the entire constellation of further network devices 10′ can have a same coverage radius per cell, which, in some embodiments, may e.g. be preconfigured in the UE 20 and/or broadcasted.

While various exemplary embodiments are described in the context of cell coverage, it is noted that the principle according to the embodiments may, without loss of generality, also be expanded to be satellite coverage, i.e. the coverage of more than one cell. In some embodiments, this may make a link between coverage on earth and satellite position simpler.

In some embodiments, the first information I-1 characterizes at least one of: a) a radio coverage RC-1 of a predetermined first number of further radio cells of the at least one further network device 10′, which will at least temporarily cover the neighbor area NA of the first radio cell C-1 within a predetermined first time interval, b) a radio coverage RC-2 of a predetermined second number of further radio cells of the at least one further network device 10′, which will at least temporarily cover the neighbor area NA of the first radio cell C-1 within a predetermined second time interval following the first time interval. In some embodiments, the first time interval may comprise several minutes or hours. In some embodiments, the second time interval may comprise several hours or days. In some embodiments, this enables UE 20 to flexibly schedule sleep and/or wakeup periods, for example taking into account operational requirements of the UE 20. As an example, this may enable UEs 20 with infrequent traffic to sleep for extended periods of time (e.g. 24 hours or more), while also avoiding them becoming “blind” in terms of future coverage.

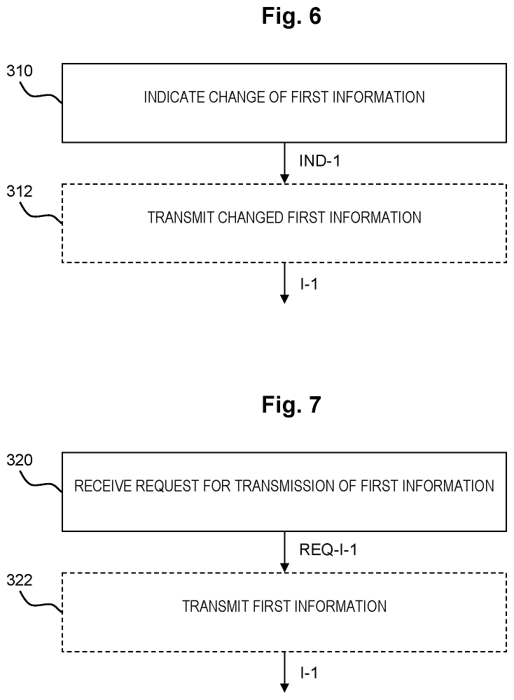

In some embodiments, FIG. 6, the instructions 106, when executed by the at least one processor 102, further cause the network device 10 to indicate 310 a change of the first information I-1. This way, the UE 20 may be notified of updates regarding the first information I-1.

In some embodiments, changes or updates of the first information I-1 may also be excluded from a change indication, for example a system information change indication according to some accepted standards (i.e. no triggering of UE 20 via paging message, for example), for example because once the UE 20 has read the coverage information from the current cell C-1 it does not necessarily need to reread until some future cell C-2 provides coverage.

In some embodiments, for example in the instance where a UE 20 calculates that all (future) cells listed in the current coverage information as e.g. characterized or represented by the first information I-1, will not provide coverage to the location of the UE 20, the UE 20 may seek to get new information, e.g. by requesting transmission of the first information I-1.

In some embodiments, a UE may decide to re-read the coverage information as e.g. characterized or represented by the first information I-1, e.g. when the satellite is closer to the location of the UE 20, since it may essentially mean the coverage information may contain more relevant cells for that UE 20.

In some embodiments, after indicating 310 the change of the first information I-1, the network device 10 may transmit the (changed or updated) first information I-1.

In some embodiments, FIG. 7, the instructions 106, when executed by the at least one processor 102, further cause the network device 10 to: receive 320 a request REQ-I-1 for transmission of the first information I-1, and, optionally, to transmit 322 the first information I-1 upon the request REQ-I-1.

Some exemplary embodiments, FIG. 4, relate to a method comprising: transmitting 302, by a network device 10, which provides a first radio cell C-1, a first information I-1 characterizing a radio coverage of at least one further radio cell C-2 of at least one further network device 10′, which at least temporarily and at least partially covers a neighbor area NA of the first radio cell C-1.

Some exemplary embodiments, FIG. 16, relate to an apparatus 100′ comprising means 102′ for causing a network device 10, which provides a first radio cell C-1, to transmit a first information I-1 characterizing a radio coverage of at least one further radio cell C-2 of at least one further network device 10′, which at least temporarily and at least partially covers a neighbor area NA of the first radio cell c-1.

Some exemplary embodiments, FIG. 2, 8, relate to an apparatus 200, comprising at least one processor 202, and at least one memory 204 storing instructions 206, the at least one memory 204 and the instructions 206 configured to, with the at least one processor 202, cause a terminal device 20 (FIG. 3) served by a first network device 10 in a first radio cell C-1 to receive 352 the first information I-1 characterizing a radio coverage of at least one further radio cell C-2 of at least one further network device 10′, which at least temporarily and at least partially covers a neighbor area NA of the first radio cell C-1.

In some embodiments, the instructions 206, when executed by the at least one processor 202, further cause the terminal device 20 to request 350 a transmission of the first information I-1.

In some embodiments, the request REQ-I-1 for the transmission may comprise an indication from the terminal device 20 about a certain time window, for example where the terminal device 20 would like to know about the coverage. As an example, with the indication, the terminal device 20 may ask or instruct the network device 10 to e.g. inform the terminal device 20 about a coverage in a time window of 4-8 hours from now.

In some embodiments, the request REQ-I-1 for the transmission may also comprise an indication from the terminal device 20 about the location of the terminal device 20 in the certain time window. In some embodiments, this enables the terminal device 20 to request information about coverage at another location, for example a location it expects to move there for the certain time window.

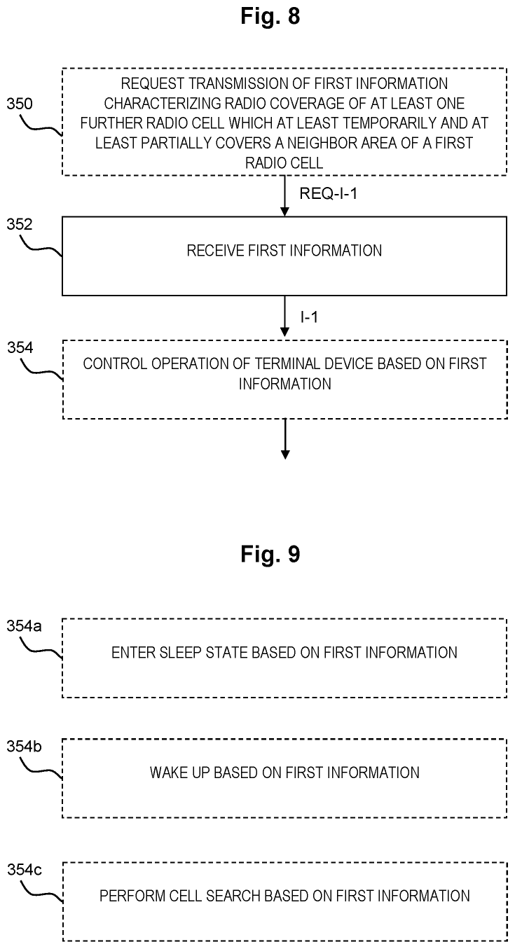

In some embodiments, the instructions 206, when executed by the at least one processor 202, further cause the terminal device 20 to perform, based at least partially on the first information I-1, at least one of: a) controlling 354 an operation of the terminal device 20, b) entering 354a (FIG. 9) a sleep state, c) waking up 354b from a sleep state.

In some embodiments, the instructions 206, when executed by the at least one processor 202, further cause the terminal device 20 to perform a cell search 354c based on the first information I-1.

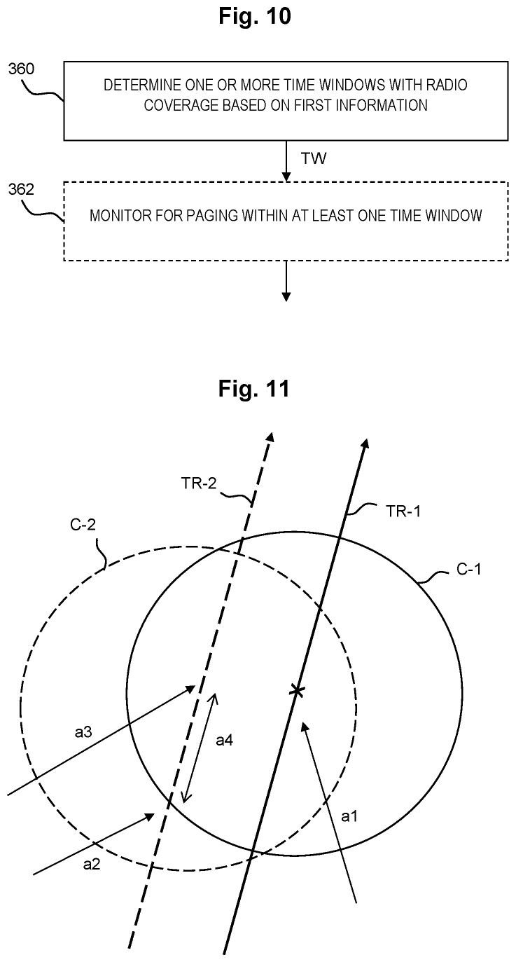

In some embodiments, FIG. 10, the instructions 206, when executed by the at least one processor 202, further cause the terminal device 20 to: determine 360 one or more time windows TW with radio coverage provided by at least one of a) the network device 10 and/or b) the at least one further network device 10′, and, optionally, to monitor 362 for paging within at least one of the one or more time windows TW.

Some exemplary embodiments, FIG. 8, relate to a method comprising: receiving 352, by a terminal device 20 served by a first network device 10 in a first radio cell C-1, a first information I-1 characterizing a radio coverage of at least one further radio cell C-2 of at least one further network device 10′, which at least temporarily and at least partially covers a neighbor area NA of the first radio cell c-1.

Some exemplary embodiments, FIG. 16, relate to an apparatus 200′ comprising means 202′ for causing a terminal device 20 served by a first network device 10 in a first radio cell C-1 to receive a first information I-1 characterizing a radio coverage of at least one further radio cell C-2 of at least one further network device 10′, which at least temporarily and at least partially covers a neighbor area NA of the first radio cell C-1.

Some exemplary embodiments relate to a wireless communications system 1 (FIG. 3) comprising at least one apparatus 100, 100′, 200, 200′ according the embodiments.

FIG. 11 schematically depicts an exemplary scenario according to some embodiments, wherein a first radio cell C-1, which may be a currently serving cell, is provided by a first network device (not shown in FIG. 11, similar to network device 10 of FIG. 3) associated with a first satellite (“Satellite A”). At further radio cell C-2 is provided by a further network device (not shown in FIG. 11, similar to network device 10 of FIG. 3) associated with a second satellite (“Satellite B”). As such, these satellite-bound network devices for example provide discontinuous radio coverage for e.g. a terrestrial UE (not shown in FIG. 11). A trajectory of the first satellite is exemplarily depicted by reference sign TR-1, and a trajectory of the second satellite is exemplarily depicted by reference sign TR-2.

Arrow a1 exemplarily depicts a position of the first satellite providing the first radio cell C-1 at a first time T1. Arrow a2 exemplarily depicts a position of the second satellite providing the second radio cell C-2 at a time Tx. Arrow a3 exemplarily depicts a position of the second satellite providing the second radio cell C-2 at a time Tx+Δ, and the double arrow a4 exemplarily depicts a movement of the further network device or it cell center, respectively, between time Tx and time Tx+Δ.

In some embodiments, the time Tx and/or the time Tx+Δ may e.g. be characterized by the exemplary elements TIM or TIM-DIFF, respectively, as exemplarily depicted by FIG. 5.

In some embodiments, the current serving cell C-1 broadcasts coverage information, e.g. in form of the first information I-1, at time T1.

At a later point in time T2, the current serving cell C-1 will broadcast the coverage information again. In some embodiments, the time between T1 and T2 can be based on a system information modification period, for example according to some accepted standard, addition/removal of future cells in the information, and/or the satellite movement of the cell C-1. For example, the first information I-1 can be sent repeatedly a number of times, but in some embodiments the first information I-1 will eventually also be updated, for example if future cells will be added/removed.

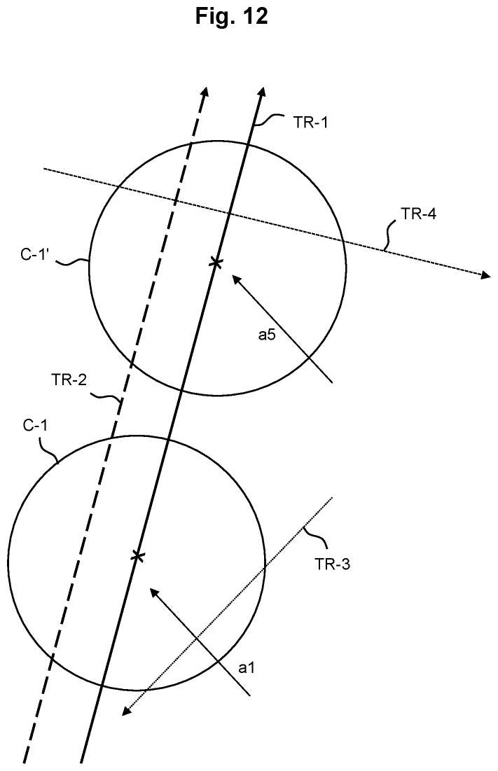

FIG. 12 schematically depicts an exemplary scenario according to some embodiments, similar to FIG. 11, but depicting further trajectories of a third satellite (trajectory TR-3) and a fourth satellite (trajectory TR-4). Arrow a5 of FIG. 12 exemplarily depicts a future position of the first satellite providing the first radio cell, indicated by reference sign C-1′, at time T2.

In some embodiments, the broadcasted coverage-related first information I-1 for the scenario according to FIG. 11, 12 can at least comprise:
a) at time T1 (first satellite at location “1”, see arrow a1):
a1) for Satellite B, e.g. the second satellite having the second trajectory TR-2: [Time Tx, position at Tx (see arrow a2 of FIG. 11), position at Tx+Δ (see arrow a3), radius of the second radio cell C-2] a2) for Satellite C, e.g. the third satellite having the third trajectory TR-3 (FIG. 12): [Time Ty, position at Ty, position at Ty+Δ, radius of a radio cell (not shown) provided by the third satellite or its further network device, respectively]
b) at time T2 (first satellite at location “2”, see arrow a5 of FIG. 12):
b1) for Satellite B, e.g. the second satellite having the second trajectory TR-2: [Time Tx2, position at Tx2, position at Tx2+Δ, radius of the second radio cell C-2]
b2) for Satellite D, e.g. the fourth satellite having the fourth trajectory TR-4: [Time Tz, position at Tz, position at Tz+Δ, radius of a radio cell (not shown) provided by the fourth satellite or its further network device, respectively].

In other words, in the exemplary embodiment explained above with reference to FIG. 11, 12, at a first point in time, i.e. at T1, the first information I-1 to be transmitted, e.g. broadcast, by the network device of the first satellite, may comprise, for the second satellite (also see item a1) mentioned above): a first time stamp TIM (also see FIG. 5), the first time stamp TIM e.g. characterizing the Time Tx, a first position information POS-1 characterizing the position at Tx (see arrow a2 of FIG. 11), a (further) first position information POS-1 characterizing the position at Tx+Δ (see arrow a3), and an estimated coverage COV-RAD characterizing the radius of the second radio cell C-2. Similar information may be provided for the for the third satellite (also see item a2) mentioned above), as well as for the situation b) at time T2, also see items b1), b2) as mentioned above.

In some embodiments, the number of satellites (or, generally, further network devices 10′) listed per time point (e.g., T1, T2, . . . ) is configurable. Presently, in the exemplary embodiments of FIG. 11, 12, the number of satellites listed per point in time is limited to two for illustration purposes.

In some embodiments, it may be that a coverage of at least some future cells C-2 may only partially overlap with a current cell's (C-1) coverage (or, in further embodiments, the coverage areas of at least some cells may not overlap at all). In view of this, in some embodiments, it may be beneficial if a UE 20 (FIG. 3) adapts its wake-up time, e.g. not only based on its traffic profile, but for example also based on an estimated coverage associated with the future cells. For example, a UE located in the area of the current cell C-1 (FIG. 12) at time T1 may determine it has something to transmit at a later point in time, but that it is not urgent. In some embodiments, the UE may therefore determine whether satellite B or C will provide the best coverage. Alternatively, the UE may note the data is time-sensitive and thus only satellite B, providing coverage at time Tx is applicable (Tx being before Ty).

In some embodiments, the first information I-1 (FIG. 3, 4) may characterize a radio coverage associated with the neighbor area NA around the current serving cell, e.g. first radio cell C-1. In some embodiments, the neighbor area NA may be divided into e.g. 8 areas (south, southwest, west, etc.). In some embodiments, alternatively or additionally, a larger radius or other coverage area than the coverage radius of the current serving cell C-1 may be used.

In some embodiments, similar coverage information as for the serving cell area, e.g. in form of the first information, can be broadcasted such that UEs moving outside the serving cell area know what coverage will be available when. In some embodiments, for example to limit an overhead, the broadcast of the neighbor areas can be interleaved, e.g. time-multiplexed, with the serving cell area information, for example with a lower frequency. Note that in some embodiments, in some cells some directions may not be needed and/or used, as there may be terrestrial coverage.

While some conventional systems provide conventional ephemeris data, which may have comparatively high precision, the principle according to the embodiments enables to efficiently provide coverage related information, e.g. the first information I-1, e.g. with sufficient precision, using a comparatively small amount of data, e.g. characterizing two positions of the at least one further network device 10′, and, for example, a time stamp and/or coverage radius.

In some embodiments, an accuracy of the positions can be limited to a desired degree, because they can e.g. be used to give the UE 20 a “rough idea” of when to wake up, i.e. some seconds or 10s of seconds of inaccuracy or tolerance may not not be critical in some embodiments, for example if coverage is available once per hour.

Some embodiments furthermore propose a concrete way to indicate future cells, e.g. by use of a timestamp TIM (FIG. 5) of or associated with at least one position, as e.g. characterized by the first position information POS-1.

In some embodiments, providing limited-precision information, e.g. the first information I-1, enables to include information about a comparatively large number of (future) cells/satellites (or associated further network devices 10′), thus providing information for a larger area and/or further ahead in time, e.g. as compared with some conventional approaches.

In some embodiments, providing at least some elements POS-1, TIM with a predetermined, limited precision and/or providing a large number of (e.g., more than two) future cells may enable the UE 20 to optimize the cell search to its own traffic and movement profiles.

In some embodiments, different elements POS-1, TIM, . . . of the first information may be transmitted with different precision each. In some embodiments, the desired precision for at least one element of the first information I-1 may e.g. be configured and/or standardized and/or negotiated between different devices 10, 20.

In some embodiments, the broadcasted coverage information, e.g. represented by the first information I-1, may apply to the entire cell coverage area, e.g. of the first cell C-1 (FIG. 3) and may enable individual UEs 20 to determine when to wake up again, see, for example, block 354b of FIG. 9.

In some embodiments, when broadcasted, the first information I-1 may be useful to both RRC Idle and RRC Connected UEs.

In some embodiments, the inclusion of information for multiple future cells in the first information I-1 allows the UE 20 to select their wake-up time based on traffic profile and best estimated coverage.

In some embodiments, having a list of multiple future cells, e.g. characterized by at least a part of the first information i-1, may enable the UE 20 to determine a last possible time to wake-up to ensure it is aware of future coverage opportunities, i.e. it may avoid the UE 20 becoming unaware of future coverage, while for example also maximizing the sleep opportunity.

In some embodiments, as the proposed list (of satellites/cells), e.g. in the form of the first information I-1, may be very compact in an information format, a comparatively large list of further network devices 10′ or respective satellites (and/or other carrier systems such as aircraft, e.g. unmanned aircraft, e.g. drones, and the like) in short space may be provided, being—at least in some embodiments-more efficient than broadcasting for example a full almanac of the constellation of satellites.

In some embodiments, it may be easier for a UE 20 to track a next coverage time based on the first information I-1 according to the embodiments than e.g. calculating the position of every satellite based on ephemeris data and an elapsed time/epoch.

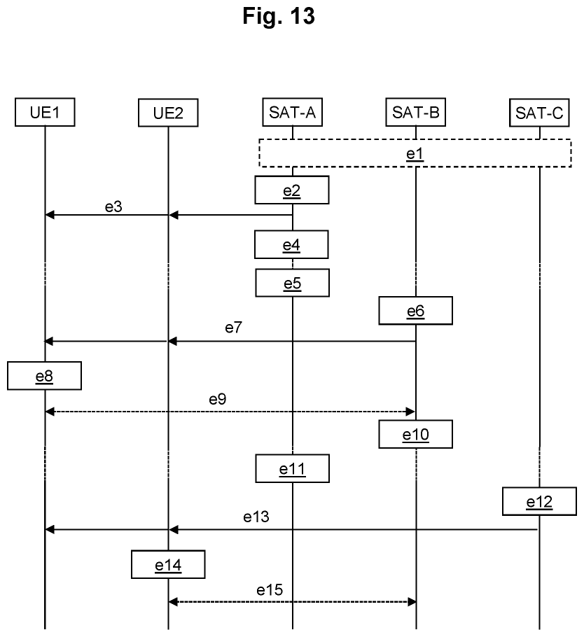

FIG. 13 illustrates potential signaling between two UEs UE1, UE2 and satellites SAT-A, SAT-B, SAT-C, each satellite SAT-A, SAT-B, SAT-C comprising a network device 10 or 10′ according to exemplary embodiments. Block e1 symbolizes a network control function optionally determining a future coverage in a current coverage area C-1 and/or in a related neighboring area NA of the first satellite SAT-A.

Block e2 symbolizes the network device of the first satellite SAT-A serving the area of the UEs UE1, UE2. Arrow e3 symbolizes the network device of the first satellite SAT-A broadcasting the first information I-1, e.g. comprising coverage information associated with the further satellites SAT-B, SAT-C or their further network devices, respectively.

Block e4 symbolizes the first satellite SAT-A leaving the area of the UEs UE1, UE2, and block e5 symbolizes a time period with no coverage in the area of the UEs UE1, UE2. Block e6 symbolizes the second satellite SAT-B entering the area of the UEs UE1, UE2, and arrow e7 symbolizes the network device of the second satellite SAT-B broadcasting the first information I-1, e.g. comprising coverage information associated with “future” satellites.

Block e8 symbolizes UE1 determining to wake up based on the broadcasted first information I-1 comprising information related to coverage associated with the second satellite SAT-B. Arrow e9 symbolizes an optional communication between UE1 and satellite SAT-B, e.g. transmitting, for example amongst other data, user data in an uplink and/or downlink direction.

Block e10 symbolizes the second satellite SAT-B leaving the area of the UEs UE1, UE2, and block e11 symbolizes a time period with no coverage in the area of the UEs UE1, UE2, e.g. similar to block 5.

Block e12 symbolizes the third satellite SAT-C entering the area of the UEs UE1, UE2, and arrow e13 symbolizes the network device of the third satellite SAT-C broadcasting the first information I-1, e.g. comprising coverage information associated with “future” satellites.

Block e14 symbolizes UE2 determining to wake up based on the broadcasted first information I-1 comprising information related to coverage associated with the third satellite SAT-C. Arrow e15 symbolizes an optional communication between UE1 and satellite SAT-C, e.g. transmitting, for example amongst other data, user data in an uplink and/or downlink direction.

In some embodiments, as e.g. explained above with respect to FIG. 11, 12, it is proposed that a position information about a location of a future cell is based on orbital or cell center positions.

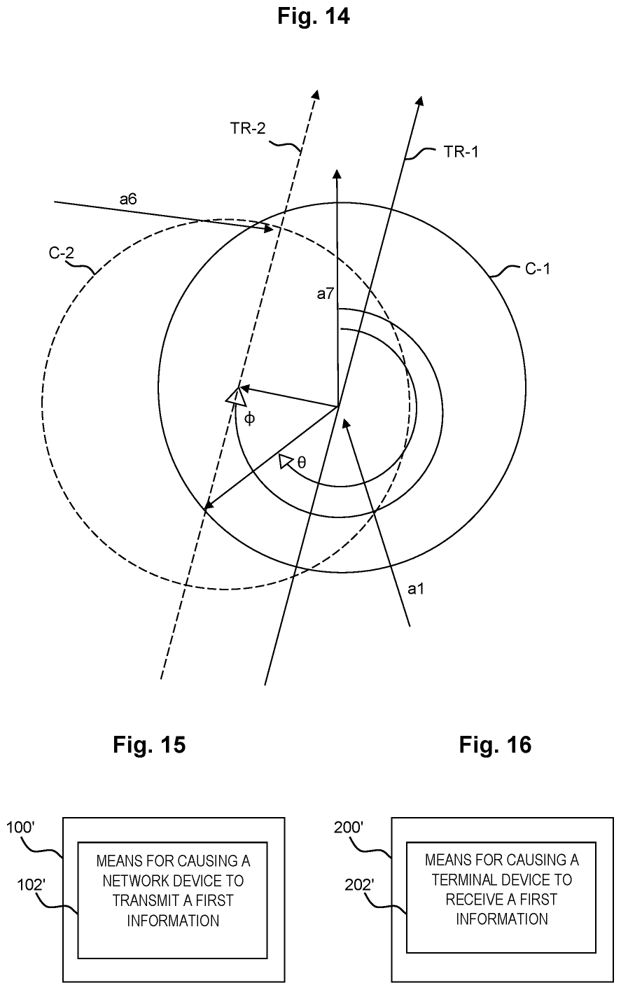

In alternative embodiments, FIG. 14, the location or position information, respectively, can e.g. be based on an angle θ at which an orbit of a target satellite passes a circle (with known radius) centered at a center a1 of the current cell C-1 (or satellite). Similarly, in some embodiments, a second point can be based either on the A movement or the exit angle (indicated by arrow a6) of the circle. In this respect, FIG. 14 exemplarily provides an illustration of the angle-based location information according to some embodiments. In some embodiments, indicating angles with less than 1 degree resolution only require 9 bits, i.e. 18 bits (e.g. characterized by elements POS-3a, POS-3b of FIG. 5)+some bits for the time stamp TIM. In some embodiments, this is estimated to be significantly less than full ephemeris information, which in some conventional approaches may consume up to or even more than 384 bits. Arrow a7 of FIG. 14 exemplarily depicts a reference direction, e.g. North direction.

In some embodiments, e.g. depending on a satellite constellation, the future cells C-2 included in the coverage information, e.g. represented by the first information, I-1 can be guaranteed to have Y % (e.g. 90%) coverage overlap with the current cell C-1. In some embodiments, if Y is sufficiently high, it is not necessary to broadcast the radius of cells, e.g. of each cell.

In some embodiments, a UE 20 being in an RRC Connected state, e.g. according to some accepted standards, can request UE location-specific coverage information, e.g. in form of the first information I-1. For example, the UE 20 can indicate its expected traffic activity, e.g. in terms of packet interarrival time, such that the network 1 can determine which satellites provide coverage at the relevant times. In some embodiments, the first information I-1 can then be provided according to the exemplary embodiments explained above.

In some embodiments, e.g. in addition to an estimation of a UE 20 when to wake up based on the first information I-1, a UE 20 may decide to, for example only, check for updates of the coverage information from satellites, which are close to the UE's own location. As an example, referring to FIG. 11, 12, if a UE at time T1 is located to the left of the satellite B orbit or trajectory TR-2, it may not be beneficial to get coverage information from satellite C having the third trajectory TR-3, because the cell(s) of satellite C may provide coverage information, which concerns areas to the far right of FIG. 12.

In some embodiments, it may also be beneficial to specify that a UE 20 is, for example only, required to monitor 362 (FIG. 10) for paging within the approximate time windows TW where there is coverage as indicated by the broadcasted first information I-1.

In some embodiments, the first information I-1 may be integrated in a System Information Broadcast (SIB) according to some accepted standard.

In some embodiments, the principle according to the embodiments may be used for Internet-of-Things, IoT, networks, for example also for non-terrestrial networks (NTN). In some embodiments, IoT NTN may provide discontinuous radio coverage on Earth, e.g. by using sparse satellite constellations. This means that a satellite may provide coverage to a certain area C-1, NA for some time after which there will be a period, where there is no NTN coverage in the area. By using the first information I-1 according to the embodiments, an efficient operation of UE can be ensured even in such (IoT) NTN configurations.

In some embodiments, the principle according to the embodiments may be used in communication systems 1, wherein at least one network device 10 according to the embodiments is provided. In other words, in some embodiments, it is not required that all network devices of a communication system 1 comprise the apparatus 100 or its functionality. Also, in some embodiments, the principle according to the embodiments may be used in mixed terrestrial/NTN networks, wherein at least one terrestrial network device and at least one non-terrestrial network device is provided. In this context, in some embodiments, it is also possible that a terrestrial or non-mobile network device at least temporarily transmits, e.g. broadcasts, the first information I-1.

1-16. (canceled)

17. An apparatus, comprising at least one processor, and at least one memory storing instructions, the at least one memory and the instructions configured to, with the at least one processor, cause a network device, which provides a first radio cell (C-1), to transmit a first information (I-1) characterizing a radio coverage of at least one further radio cell (C-2) of at least one further network device, which at least temporarily and at least partially covers a neighbor area (NA) of the first radio cell (C-1).

18. The apparatus according to claim 17, wherein at least one of the network device and the at least one further network device is a mobile network device, for example a non-terrestrial network device.

19. The apparatus according to claim 17, wherein the first information (I-1) comprises at least one of: a) first position information (POS-1) characterizing at least one position of the at least one further network device, b) a timestamp (TIM) characterizing a time and/or date on which the at least one further network device is at the at least one position (POS-1), c) second position information (POS-2) characterizing at least one center position of the at least one further radio cell (C-2), d) a time difference (TIM-DIFF) between two points in time, wherein each of the two points in time is associated with a respective position of the at least one further network device or a respective center position of the at least one further radio cell (C-2), e) an estimated coverage radius (COV-RAD) of the at least one further radio cell (C-2), f) a first indicator (IND-1) indicating that an estimated coverage radius (COV-RAD) of the at least one further radio cell (C-2) is at least similar to a coverage radius of the first radio cell (C-1), g) first angle-based position information (POS-3a) characterizing at least one angle at which a trajectory of the at least one further network device passes a circle centered at at least one of a center of the first radio cell (C-1) or a current position of the network device, h) second angle-based position information (POS-3b) characterizing at least one angle at which a trajectory of the at least one further network device leaves a circle centered at at least one of a center of the first radio cell (C-1) or a current position of the network device.

20. The apparatus according to claim 17, wherein the first information (I-1) characterizes at least one of: a) a radio coverage (RC-1) of a predetermined first number of further radio cells (C-2) of the at least one further network device, which will at least temporarily cover the neighbor area (NA) of the first radio cell (C-1) within a predetermined first time interval (TI-1), b) a radio coverage (RC-2) of a predetermined second number of further radio cells (C-2) of the at least one further network device, which will at least temporarily cover the neighbor area (NA) of the first radio cell (C-1) within a predetermined second time interval (TI-2) following the first time interval (TI-1).

21. The apparatus according to claim 17, wherein the instructions, when executed by the at least one processor, further cause the network device to indicate a change of the first information (I-1).

22. The apparatus according to claim 17, wherein the instructions, when executed by the at least one processor, further cause the network device to: receive a request (REQ-I-1) for transmission of the first information (I-1).

23. A method comprising: transmitting, by a network device, which provides a first radio cell (C-1), a first information (I-1) characterizing a radio coverage of at least one further radio cell (C-2) of at least one further network device, which at least temporarily and at least partially covers a neighbor area (NA) of the first radio cell (C-1).

24. An apparatus, comprising at least one processor, and at least one memory storing instructions, the at least one memory and the instructions configured to, with the at least one processor, cause a terminal device served by a first network device in a first radio cell (C-1) to receive a first information (I-1) characterizing a radio coverage of at least one further radio cell (C-2) of at least one further network device, which at least temporarily and at least partially covers a neighbor area (NA) of the first radio cell (C-1).

25. The apparatus of claim 24, wherein the first information (I-1) comprises at least one of: a) first position information (POS-1) characterizing at least one position of the at least one further network device, b) a timestamp (TIM) characterizing a time and/or date on which the at least one further network device is at the at least one position (POS-1), c) second position information (POS-2) characterizing at least one center position of the at least one further radio cell (C-2), d) a time difference (TIM-DIFF) between two points in time, wherein each of the two points in time is associated with a respective position of the at least one further network device or a respective center position of the at least one further radio cell (C-2), e) an estimated coverage radius (COV-RAD) of the at least one further radio cell (C-2), f) a first indicator (IND-1) indicating that an estimated coverage radius (COV-RAD) of the at least one further radio cell (C-2) is at least similar to a coverage radius of the first radio cell (C-1), g) first angle-based position information (POS-3a) characterizing at least one angle at which a trajectory of the at least one further network device passes a circle centered at at least one of a center of the first radio cell (C-1) or a current position of the network device, h) second angle-based position information (POS-3b) characterizing at least one angle at which a trajectory of the at least one further network device leaves a circle centered at at least one of a center of the first radio cell (C-1) or a current position of the network device.

26. The apparatus of claim 24, wherein the instructions, when executed by the at least one processor, further cause the terminal device to: request a transmission of the first information (I-1).

27. The apparatus of claim 24, wherein the instructions, when executed by the at least one processor, further cause the terminal device to perform, based at least partially on the first information (I-1), at least one of: a) controlling an operation of the terminal device, b) entering a sleep state, c) waking up from a sleep state.

28. The apparatus of claim 24, wherein the instructions, when executed by the at least one processor, further cause the terminal device to: determine one or more time windows (TW) with radio coverage provided by at least one of a) the network device and/or b) the at least one further network device.
